(19) United States
(12) Patent Application Publication
(10) Pub. No.: US 2016/0031140 A1
(43) Pub. Date: Feb. 4, 2016

(54) Method for Producing a Mold for Producing a Fiber Composite Component

(71) Applicant: Bayerische Motoren Werke Aktiengesellschaft, Muenchen (DE)

(72) Inventors: Thomas PASSREITER, Geiselhoering (DE); David FUCHS, Landshut (DE); Bernhard STAUDT, Muenchen (DE); Steffen BECK, Muenchen (DE); Johannes ESCHL, Groebenzell (DE)

(21) Appl. No.: 14/884,178

(22) Filed: Oct. 15, 2015

Related U.S. Application Data
(63) Continuation of application No. PCT/EP2014/060230, filed on May 19, 2014.

(30) Foreign Application Priority Data
May 23, 2013 (DE) 10 2013 209 611.9

(51) Int. Cl. B29C 45/80; B29C 45/00

(52) U.S. Cl. CPC B29C 45/80; B29C 45/0005; B29K 2101/00

(57) ABSTRACT

A method is provided for producing a mold for producing a fiber composite component having at least one fiber-containing material and at least one matrix material. The mold includes at least one tool upper mold part, a tool lower mold part, and a gap lying between the upper part and the lower part. The method determines an expected thickness of the fiber-containing material in at least one region of the fiber-containing material, and adapts a width of the gap of the mold according to the expected thickness of the fiber-containing material in the corresponding region of the gap.

### CROSS REFERENCE TO RELATED APPLICATIONS

This application is a continuation of PCT International Application No. PCT/EP2014/060230, filed May 19, 2014, which claims priority under 35 U.S.C. §119 from German Patent Application No. 10 2013 209 611.9, filed May 23, 2013, the entire disclosures of which are herein expressly incorporated by reference.

### BACKGROUND AND SUMMARY OF THE INVENTION

The present invention relates to a method for producing a mold for producing a fiber composite component, and to a method for producing the fiber composite component itself.

Fiber composite components are characterized by excellent mechanical properties, and additionally by a very low inherent weight compared to conventional metallic materials. Fiber composite components are therefore used for a variety of lightweight construction applications, in particular in automobile construction, where weight savings of the components, along with excellent strength and rigidity, play an important role. Fiber composite components are usually produced using resin infusion methods, where fiber-containing materials, known as semi-finished fiber products, such as laid scrim, interlaced fabrics, knitted fabrics or the like, are initially inserted into a female mold part of a mold, and covered with a film and tensioned together with the same. By applying a vacuum, a matrix material, which is typically a resin, is introduced. The matrix material saturates the fiber-containing material. Because the pressure gradient acting on the resin in the resin infusion method is low, infusion times are very long. Moreover, because the flow behavior of the matrix material is difficult to control, this method is not suited for fiber composite components having archings, corners and depressions, or often areas are created there that contain pure resin regions, air inclusions and regions having varying fiber volume contents form. This lowers the quality of the fiber composite component. This method is also very time-intensive, making it poorly suited for large-scale mass production of fiber composite components.

Alternatively to the resin infusion process, what are known as (high-pressure) RTM processes or resin injection processes are employed. Here, a preformed fiber-containing material (preform) is introduced into a mold having the intended net shape of the fiber composite component to be produced, and with a vacuum applied to the mold, a matrix material is injected. The matrix material saturates the fiber-containing material. The fiber composite component can be removed from the mold after the matrix material has cured. The disadvantage of this method is that once again pure resin regions and air inclusions are formed, in particular in areas having archings, corners and depressions, as a result of the fiber-containing material being compressed, and optionally deformed, when it is inserted and draped in the mold, such as when the parts of the mold are closed. A matrix material film then forms, in particular on the surface of the fiber composite component, so that the fiber composite component has inhomogeneous mechanical properties.

Proceeding from this prior art, it is therefore the object of the present invention to provide a method for producing a mold having at least one upper mold part, a lower mold part, and a gap in between, for producing a fiber composite component, whereby the width of the gap is optimized such that a fiber composite component having excellent mechanical properties can be produced without defects, such as pure resin regions, matrix material films on the surface and air inclusions. It is a further object of the invention to provide a method for producing a fiber composite component, which is suited for mass production and creates a fiber composite component of high quality having no process-related inhomogeneities.

According to the invention, this and other objects are achieved in a method for producing a mold for producing a fiber composite component, which comprises at least one fiber-containing material and at least one matrix material, wherein the mold comprises at least one upper mold part, a lower mold part, and a gap in between, by the following acts:

a) determining the thickness of the fiber-containing material to be expected in at least one region of the fiber-containing material; and

b) adapting a width of the gap of the mold in accordance with the theoretical thickness of the fiber-containing material to be expected in the corresponding region of the gap.

By adapting and optimizing the gap width as a function of the thickness of the fiber-containing material to be expected, air inclusions and cavities are effectively avoided in the fiber-containing material, and in particular on the surfaces thereof adjoining the mold surfaces. In this way, a formation of pure resin regions and inhomogeneous fiber volume regions can be prevented. According to the invention, the thickness of the fiber-containing material to be expected shall be understood to mean the thickness of the fiber-containing material that results from compressing and draping the fiber-containing material when the same is inserted into the mold and the mold is closed. Especially in severely curved areas, high compression pressure acts on the fiber-containing material in the mold. As a result, the material is compressed in these areas, while it has a greater thickness in less severely curved areas due to spreading of the fibers or build-up of the fibers. The thickness to be expected can be practically determined by experimentation and/or be calculated based on the properties of the particular fiber-containing material that is used. The thickness that is theoretically to be expected is determined in at least one area of the fiber-containing material, but can preferably be determined in multiple areas, whereby a gap width that is optimized across the entire length of the mold can be obtained. The method according to the invention is easy to use and results in the production of a highly precise mold that allows fiber composite components to be manufactured in high quality in a process that is suitable for large-scale production.

According to one advantageous refinement, act a) comprises an act of determining the minimal thickness of the fiber-containing material. The minimal thickness of the fiber-containing material is the thickness at which the fibers have a maximum densely packed state prior to adding the matrix material, without irreversible deformation or damage of the fibers occurring. The minimal thickness can be obtained by compressing the fiber-containing material, for example, or it can be determined using a simulation program. In the first case, for example, the fiber-containing material is exposed to rising pressure in pre-tests. The fiber-containing material is compressed by applying the pressure. The minimal thickness of the fiber-containing material is reached when a further increase in pressure causes visually discernible irreversible deformation or damage of the fiber-containing material. The minimal thickness within the meaning of the present invention is the thickness of the material that is present at the maximum pressure that does not yet result in damage or irreversible deformation of the fiber-containing material. This thickness is easy to measure on the fiber material in the compressed state using a micrometer gauge or a ruler. A compression test on a universal testing machine is advantageous. A comparable value can also be obtained by using an alternative method act, which is to say by using a corresponding simulation program. Here, the pressure acting on the fibers is determined, based on which the compression of the fiber-containing material is determined. In particular the fiber volume content, the fiber arrangement, the structure and composition of the fibers, and the mechanical and physical properties thereof, are considered in the calculation. By taking the minimal thickness of the fiber-containing material into consideration when adapting the gap, in particular pure resin regions on the surface of the fiber composite component can be avoided particularly effectively because the gap width is selected in such a way that the fibers in any case are seated against the respective inner mold surface in maximal density when the mold is closed.

It is further advantageous for act a) to include an adaptation of the thickness of the fiber-containing material to be expected, so that shear effects and expansion effects transverse to the fiber are created, which result from mechanical action on the fiber-containing material when the fiber-containing material is inserted and draped in the mold. The mold is, in particular, a preform mold or also an RTM mold. This is especially advantageous when forming curved areas, and in the area of potential tensioning of the fiber-containing material, and therefore in particular in the edge areas. This is because here fiber volume rich or fiber volume poor regions are formed when the component wall thickness is not adapted. These phenomena cause the fiber material to thin out in some areas, and to accumulate in other areas, which decisively influences the fill level of the mold gap. This causes undesirable pure resin regions and air inclusions to form with preference in low-fiber areas. Taking these phenomena into consideration results in an optimized gap width, whereby fiber composite components having a homogeneous composition are obtained, which are free of pure resin regions and air inclusions, and therefore are of an excellent quality.

According to the invention a method for producing a fiber composite component is also described, wherein the fiber composite component comprises at least one fiber-containing material and at least one matrix material, and is produced in a mold that comprises at least one upper mold part, a lower mold part, and a gap in between. The method according to the invention is characterized by the following acts:

a) determining the thickness of the fiber-containing material to be expected in at least one region of the fiber-containing material;

b) adapting a width of the gap of the mold in accordance with the thickness of the fiber-containing material to be expected in the corresponding region of the gap;

c) inserting the fiber-containing material in the mold;

d) closing the mold; and

e) introducing at least one matrix material.

The above-described method can be used to produce fiber composite components of high quality on a large scale with high throughput. By using a mold that is optimized with respect to the fiber composite component to be produced, having a defined gap width that is adapted with respect to the layer thickness of the fiber composite component to be produced, air inclusions, pure resin regions and a film formation of matrix material on the surface of the fiber composite component are prevented. The method is easy and cost-effective to implement, effectively reduces the need for modifications to molds, such as RTM molds, and is excellently suited for mass production due to the efficiency and time-saving method steps. Customary method steps, such as applying a vacuum for improved distribution of the matrix material, controlling the temperature, curing the matrix material and the like, can complete the method according to the invention.

The method act a) advantageously comprises an act of determining the minimal thickness of the fiber-containing material. This thickness is as defined above and can be ascertained, for example, by compressing the fiber-containing material or by using a simulation program. As was already explained, the minimal thickness obtainable by compression of the fiber-containing material is the thickness of the fiber material that is obtained by applying a pressure just below the level that results in irreversible deformation or damage of the fiber-containing material, wherein a corresponding value can also be obtained by using appropriate simulation programs. By considering this value in the determination of the theoretical thickness of the fiber-containing material to be expected, and by subsequently adapting the gap width of the mold that is used based on this value, air inclusions and pure resin regions can be avoided particularly well on the respective surface of the fiber composite material that is oriented toward the inner mold surface. The matrix material therefore primarily penetrates into the cavities formed by the fibers and spreads inside the fiber-containing material.

The refinements, advantages and effects according to the invention described for the method according to the invention for producing a mold for producing a fiber composite component can also be applied to the method according to the invention for producing a fiber composite component.

For the reasons cited above, act a) preferably also includes an adaptation of the theoretical thickness of the fiber-containing material to be expected, in which shear effects and effects resulting from mechanical action on the fiber-containing material when the fiber-containing material is inserted and draped in the mold are considered. In this way, in particular fiber composite components having complex shapes can be produced in high quality, wherein the method can also be used for prepreg materials.

The fiber-containing material further advantageously is a preform or a prepreg. These fiber-containing materials can be easily processed on a large scale by way of the method according to the invention, without high technical complexity, to obtain fiber composite components. When using a preform, the effects according to the invention become apparent particularly well because they are subject to very high compressibility, which in customary methods results in a high proportion of pure resin regions and air inclusions, which are effectively avoided by the method according to the invention. Moreover, preforms have high degrees of design freedom and are available in arbitrary shapes at low cost.

According to one advantageous refinement, the preform comprises at least one layer of a laid fiber scrim, fiber mesh, interlaced fiber fabric, or knitted fiber fabric. These preforms are very easy to process further in the mold according to the invention, using the method according to the invention, to form a fiber composite component, and they can be draped very well in any arbitrary shape in the mold, whereby fiber composite components can be produced in desired, even complex, shapes.

According to the invention a fiber composite component is also described, which is obtained by the above-described method for producing a fiber composite component. The fiber composite component is characterized by a homogeneous fiber volume content, is free of air inclusions, pure resin regions and surface films made of matrix material, and therefore has an excellent and homogeneous quality.

The following advantages result based on the approaches according to the invention and the refinements according to the invention:

1) the method according to the invention for producing a mold for producing a fiber composite component allows a highly precise mold to be manufactured in a simple and cost-effective manner, which is suitable for producing fiber composite components in excellent quality;

2) the method for producing a fiber composite component is highly efficient, cost-effective, and suitable for mass production; and

3) the produced fiber composite components are characterized by a high quality and the absence of defects, such as pure resin regions, air inclusions and surface films made of matrix material.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a sectional view through a portion of a mold according to an embodiment of the invention;

FIG. 2 is a sectional view through a mold for producing a fiber composite component according to the related art;

FIG. 3 is a sectional view through a mold for producing a fiber composite component, which was produced according to one refinement of the exemplary method according to the invention;

FIG. 4 is a further sectional view through the mold of FIG. 3; and

FIG. 5 is a diagram for determining the minimal thickness obtainable by compression of a fiber-containing material.

### DETAILED DESCRIPTION OF THE DRAWINGS

The figures show only the parts and components that are of interest here, while all remaining elements such as the mold or the preform have been omitted for the sake of clarity. In the figures, identical reference numerals denote identical components.

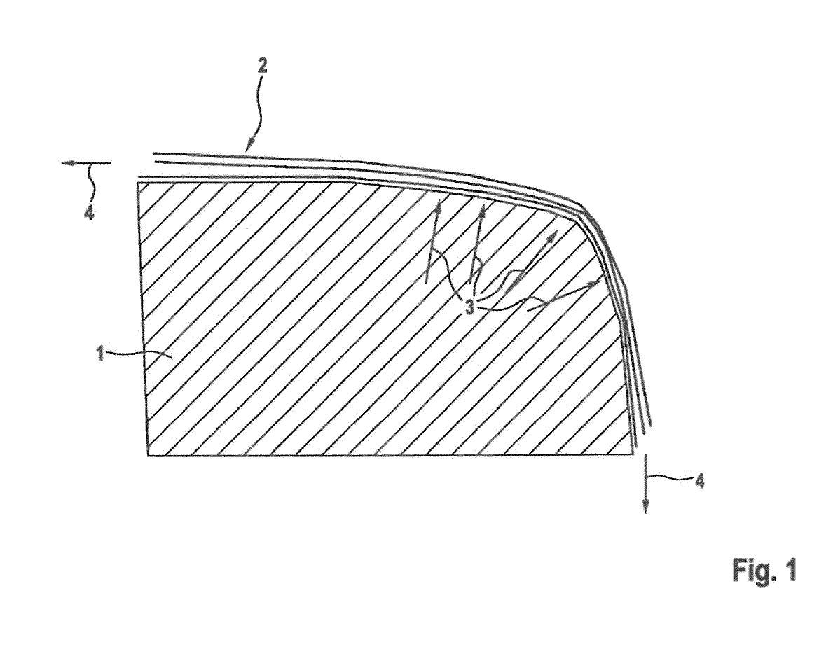

FIG. 1 shows a bottom side 1 of a mold for producing a fiber composite component. A preform 2, which here includes three preform layers, for example, is disposed on the surface. Reference numerals 3 and 4 show areas in which particularly high forces act on the preform during draping of the preform layers. In area 3 of the mold 1, high pressure acts from beneath on the preform layers as a result of the severe curvature, the preform layers being compressed at this location corresponding to the pressure during draping and becoming thinned. Preform layers in which the fibers are located transversely to the tensile direction are expanded. Depending on the friction in the radius, the action of the tensile forces differs in areas 3 and 4, resulting in different preform thicknesses. In addition, the increase in thickness of the preform due to shearing or compression is taken into consideration. The acting forces influence the formation of defects or air inclusions and pure resin regions, provided that the gap of the mold has not been appropriately adapted.

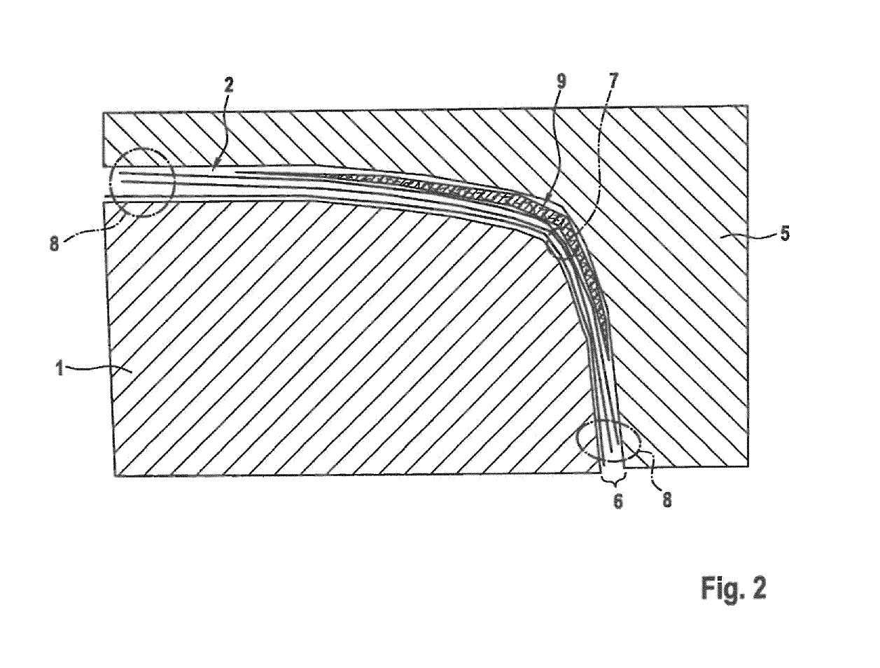

FIG. 2 shows a sectional view through a mold for producing a fiber composite component according to the related art. The mold comprises a lower mold part 1 and an upper mold part 5. After the mold has been closed, a gap 6 results between the lower mold part 1 and the upper mold part 5. A preform 2 having three preform layers, for example, is located in the gap here. By inserting the perform layers and draping the same in the mold, forces have acted on the preform 2, so that the preform has a compressed region 7 having a lower fiber volume content where high pressure acted on the preform 2, and it has regions 8 having a high fiber volume content where high tensile forces acted. An area free of material was therefore developed in particular between the compressed region 7 and the upper mold part 5, and a pure resin region 9 therefore developed after matrix material was filled in, the pure resin region 9 creating quality inhomogeneity in the resulting fiber composite component.

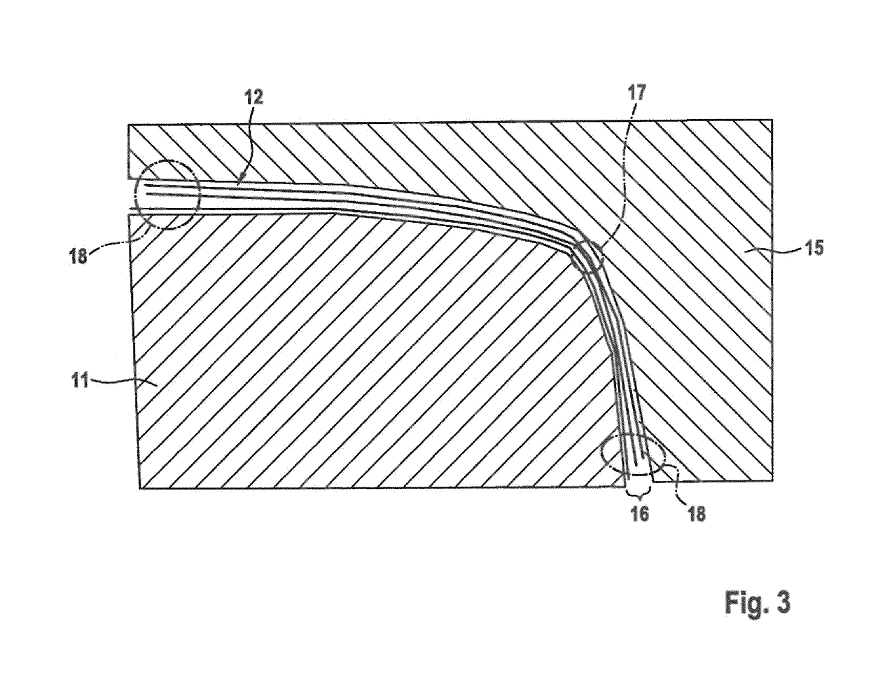

FIG. 3 shows a sectional view through a mold for producing a fiber composite component, which was produced according to one refinement of the method according to the invention. The mold includes a lower mold part 11, an upper mold part 15, and a gap 16 in between. A preform 12 is located in the gap, the preform being formed of three preform layers here, for example. The same forces acting on the preform 2 in FIG. 2 act on the preform 12; however in FIG. 3 the gap width of the mold is adapted in accordance with the invention based on the theoretical thickness of the preform 12 to be expected. Moreover, both the pressure forces acting on the preform 12 in region 17 and tensile forces action in the regions 18, which directly impact the thickness of the preform 12, are advantageously taken into consideration. In region 17, high pressure acted on the preform 12 due to the curvature of the mold in this region, which has resulted in a compression of the fiber-containing material and in a lower fiber volume content. The gap width was therefore reduced in this region. Regions having a high fiber volume content developed in the regions 18 where high tensile forces acted on the preform 12, and the gap 16 has been accordingly widened in this region. In this way, pure resin regions, matrix material films on the surface of the fiber composite component, and air inclusions are effectively avoided in the production of the fiber composite component.

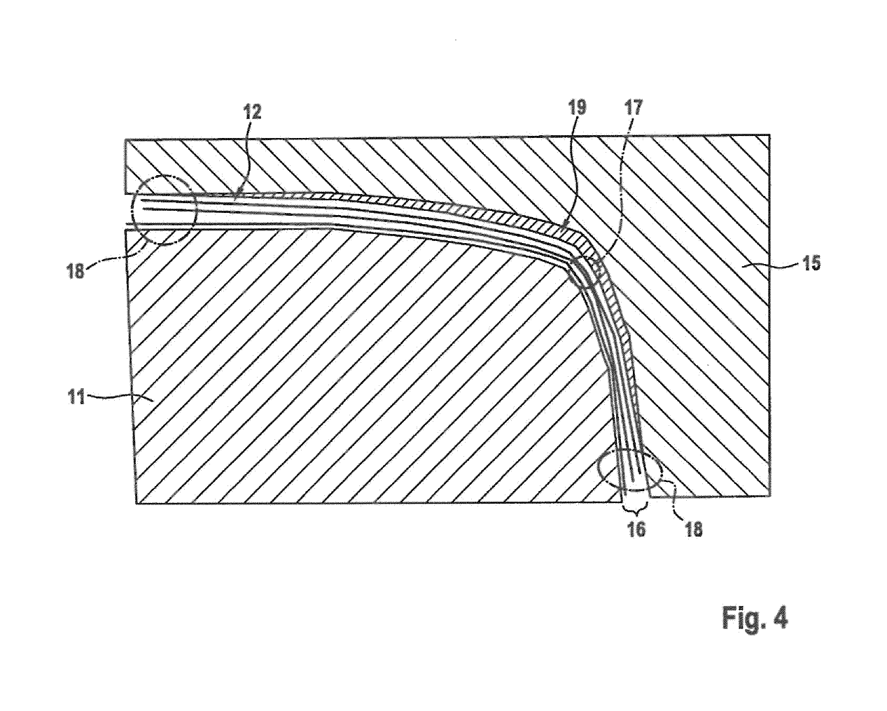

FIG. 4 shows the same mold as in FIG. 3; however here, the adaptation area 19 is shown in the upper mold face, which forms part of the upper mold part 15 and was added by adapting the gap width to the thickness of the preform 12 to be expected, so as to make an optimal gap width available, which effectively prevents the formation of pure resin regions.

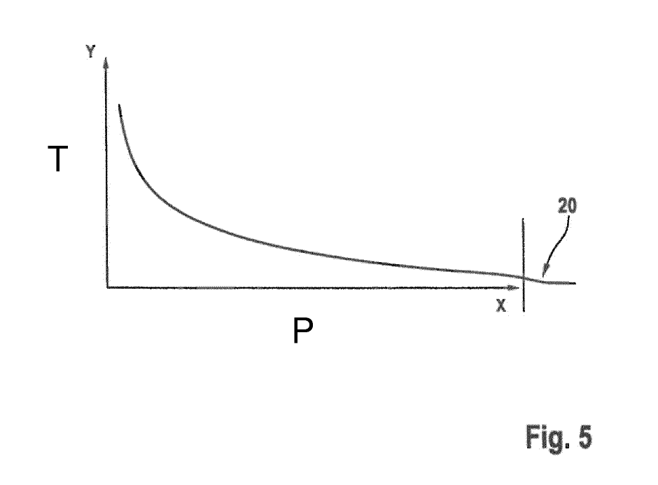

FIG. 5 shows a diagram for determining the minimal thickness obtainable by compression of a fiber-containing material. The compression pressure is plotted on the X-axis, and the material thickness is plotted on the Y-axis. The obtainable minimal thickness is reached when irreversible damage or deformation of the fiber-containing material occurs with further increasing pressure. This is apparent in the graph based on the sudden drop in material thickness in area 20. The graphical plotting of the material thickness against the compression pressure allows the obtainable minimal thickness to be read directly from the diagram.

The above description of the present invention serves only illustrative purposes and is not intended to limit the invention. Within the context of the invention, various changes and modifications are possible without departing from the scope of the invention or the equivalents thereof.

### LIST OF REFERENCE NUMERALS

1, 11 lower mold part
2, 12 preform
3 region of high pressure
4 region of high tensile force
5, 15 upper mold part
6, 16 gap
7, 17 region having low fiber volume content
8, 18 region having high fiber volume content
9 pure resin region
19 adaptation area
20 area of sudden drop in the fiber material thickness

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a mold for producing a fiber composite component comprising at least one fiber-containing material and at least one matrix material, wherein the mold comprises at least one upper mold part, a lower mold part, and a gap in between, the method comprising the acts of:
a) determining a thickness of the fiber-containing material to be expected in at least one area of the fiber-containing material; and
b) adapting a width of the gap of the mold in accordance with the determined thickness of the fiber-containing material to be expected in the corresponding area of the gap.

2. The method according to claim 1, wherein the act of determining the thickness comprises the act of determining a minimal thickness of the fiber-containing material.

3. The method according to claim 2, wherein the act of determining the thickness is carried out by adapting the thickness of the fiber-containing material to be expected, in which shear effects and effects resulting from mechanical action on the fiber-containing material when the fiber-containing material is inserted and draped in the mold are considered.

4. The method according to claim 1, wherein the act of determining the thickness is carried out by adapting the thickness of the fiber-containing material to be expected, in which shear effects and effects resulting from mechanical action on the fiber-containing material when the fiber-containing material is inserted and draped in the mold are considered.

5. A method for producing a fiber composite component comprising at least one fiber-containing material and at least one matrix material in a mold, wherein the mold comprises at least one upper mold part, a lower mold part, and a gap in between, the method comprising the acts of:
a) determining a thickness of the fiber-containing material to be expected in at least one area of the fiber-containing material;
b) adapting a width of the gap of the mold in accordance with the determined thickness of the fiber-containing material to be expected in the corresponding area of the gap;
c) inserting the fiber-containing material in the mold;
d) closing the mold; and
e) introducing at least one matrix material into the mold.

6. The method according to claim 5, wherein the act of determining the thickness comprises the act of determining a minimal thickness of the fiber-containing material.

7. The method according to claim 6, wherein the act of determining the thickness is carried out by adapting the thickness of the fiber-containing material to be expected in which shear effects and effects resulting from mechanical action on the fiber-containing material when the fiber-containing material is inserted and draped in the mold are considered.

8. The method according to claim 5, wherein the act of determining the thickness is carried out by adapting the thickness of the fiber-containing material to be expected in which shear effects and effects resulting from mechanical action on the fiber-containing material when the fiber-containing material is inserted and draped in the mold are considered.

9. The method according to claim 5, wherein the fiber-containing material is one of a preform or a prepreg.

10. The method according to claim 6, wherein the fiber-containing material is one of a preform or a prepreg.

11. The method according to claim 7, wherein the fiber-containing material is one of a preform or a prepreg.

12. The method according to claim 9, wherein the preform comprises at least one layer of a laid fiber scrim, fiber mesh, interlaced fiber fabric or knitted fiber fabric.

13. A fiber composite component produced by the method according to claim 5.

14. A fiber composite component produced by the method according to claim 12.
